(19) United States
(12) Patent Application Publication
(10) Pub. No.: US 2022/0337931 A1
(43) Pub. Date: Oct. 20, 2022

(54) ACOUSTIC CHAMBER AND VENTING SYSTEMS AND METHODS

(71) Applicant: Kingston Technology Corporation, Fountain Valley, CA (US)

(72) Inventors: Wei-Min Liang, Hsinchu City (CN); Wen Ning Chang, Taipei City (CN)

(21) Appl. No.: 17/232,575

(22) Filed: Apr. 16, 2021

(51) Int. Cl. H04R 1/10

(52) U.S. Cl. CPC H04R 1/1008; H04R 1/1075; H04R 2460/11

(57) ABSTRACT

Embodiments of the inventive subject matter described in this application are directed to headset audio systems that incorporate components designed to improve sound reproduction in certain ranges. For example, in some embodiments, an acoustic chamber and a venting portion are incorporated into an internal portion of a headset audio system such that the vent is configured to improve bass response. Different vent shapes and sizes can affect speaker performance. Moreover, in some embodiments, the acoustic chamber can additionally include a vent.

### FIELD OF THE INVENTION

The field of the invention is headset audio equipment.

### BACKGROUND

The background description includes information that may be useful in understanding the present invention. It is not an admission that any of the information provided in this application is prior art or relevant to the presently claimed invention, or that any publication specifically or implicitly referenced is prior art.

Headsets are becoming increasingly complex pieces of electronic equipment. Modern headsets can include surround sound, noise cancellation, wireless charging, wireless circuitry, batteries, etc. Headset earcups can be filled with components to make these different features possible, which can result in asymmetries between the earcups of a headset. For example, a headset capable of wireless charging can include a battery in a left earcup with associated wireless charging hardware in the right earcup. Components are typically distributed between left and right earcups so that weight distribution between each earcup is balanced, but this can result in earcups having asymmetric internal configurations, which can create inconsistent sound reproduction between left and right earcups despite identical sound reproduction components.

Asymmetric sound reproduction can, in some cases, be corrected by signal processing. For example, when the frequency response of a left earcup indicates that a certain frequency range is depressed compared to a right earcup, signal processing techniques can be implemented to bring the two earcups to parity. But correcting these issues via signal processing can be overly burdensome, requiring unique signal processing solutions for every headset. It would be preferable to have a one-size-fits-all solution that does not require implementation of signal processing correction. Such a solution would ideally be mechanical in nature (i.e., not requiring any additional electronics or specialized software).

Some mechanical solutions exist, such as those demonstrated in the HIFIMAN HE1000, which includes an almost-fully open earcup outer covering. But to include an entirely open back requires sacrifices that render such a solution incompatible with many different features that users often look for. For example, with an open back, there can be no internal components inside the earcup in between the sound driver and the open back. This creates serious design constraints that can prevent incorporation of features such as wireless connections and wireless charging.

Headsets having some volume of space behind a sound driver have been contemplated before, as demonstrated in U.S. Pat. No. 9,942,648 to Azmi et al. But Azmi et al. discloses a chamber behind a sound driver in an earbud, the chamber must be formed as a part of the earbud, and it does not create additional space for other internal components. Moreover, past efforts have also failed to appreciate that such acoustic chambers can incorporate specialized venting systems that facilitate frequency response tuning.

Thus, there remains a need in the art for a mechanical solution to the asymmetry problem created when headsets incorporate a wide variety of features requiring internal earcup space that also improves frequency response in desired frequency ranges.

### SUMMARY OF THE INVENTION

The present invention is directed to systems and methods relating to headset audio systems that are intended to improve frequency response in certain ranges, such as the bass range.

In one aspect of the inventive subject matter, a headset audio system is contemplated, the system comprising: a diaphragm mount comprising an annular vent; a speaker diaphragm coupled with the diaphragm mount and configured to generate sound, wherein the speaker diaphragm and the diaphragm mount form an annular space and a center space; a chamber and vent element comprising an acoustic chamber, a horn-shaped vent passage, and a vent output; wherein a first portion of sound generated by the speaker diaphragm passes through the annular vent into the acoustic chamber; wherein a second portion of sound generated by the speaker diaphragm passes through a center passageway into the horn-shaped vent passage and out the vent output.

In some embodiments, the acoustic chamber also includes a vent. In some embodiments, the annular vent is covered by an air permeable membrane. In some embodiments, another air permeable membrane can be disposed between the center passageway and an internal vent opening that leads to the horn-shaped vent passage.

In some embodiments, the vent output has a first cross-sectional area and an internal vent opening that leads to the horn-shaped vent passage having a second cross-sectional area, and the first cross-sectional area is less than half that of the second cross-sectional area. In some embodiments, the horn-shaped vent passage expands linearly. In some embodiments, the system also includes an internal vent opening disposed between the horn-shaped vent passage and the center passageway, where the internal vent opening is disposed orthogonally to the vent output.

In another aspect of the inventive subject matter, a headset audio system is contemplated to include: an enclosure; a driver cover coupled with the enclosure to create an internal space; a chamber and vent element disposed within the internal space and coupled with both the enclosure and the driver cover; a diaphragm mount coupled with the driver cover and comprising at least one vent; a speaker diaphragm coupled with the diaphragm mount and configured to generate sound, where the speaker diaphragm and the diaphragm mount form an annular space and a center space; a chamber and vent element comprising an acoustic chamber, a horn-shaped vent passage, and a vent output; where a first portion of sound generated by the speaker diaphragm passes through the annular vent into the acoustic chamber; where a second portion of sound generated by the speaker diaphragm passes through a center passageway into the horn-shaped vent passage and out the vent output.

In some embodiments, the acoustic chamber comprises a vent., and, in some embodiments, the annular vent can be covered by an air permeable membrane. In some embodiments, an air permeable membrane is disposed between the center passageway and an internal vent opening that leads to the horn-shaped vent passage. In some embodiments, the vent output comprises a first cross-sectional area and an internal vent opening that leads to the horn-shaped vent passage comprises a second cross-sectional area, and the first cross-sectional area is less than half of the second cross-sectional area. In some embodiments, the horn-shaped vent passage expands linearly. It is contemplated that the system can also include an internal vent opening disposed between the horn-shaped vent passage and the center passageway, where the internal vent opening is disposed orthogonally to the vent output. In some embodiments, the speaker diaphragm couples with an underside of the driver cover.

One should appreciate that the disclosed subject matter provides many advantageous technical effects including an ability to improve frequency response in headset audio systems, especially in the bass range. Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a plan view of a system of the inventive subject matter.

FIG. 2 is a cutaway view thereof.

FIG. 3 is a bottom view showing the acoustic chamber and vent passage thereof.

FIG. 4 is another cutaway view thereof.

FIG. 5 shows the chamber and vent element thereof.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Embodiments of the inventive subject matter are directed to headset audio systems having one or more audio chambers on the backside of the headset's speaker diaphragm and also having a horn-like venting structure tuned to improve bass performance of the headset audio system.

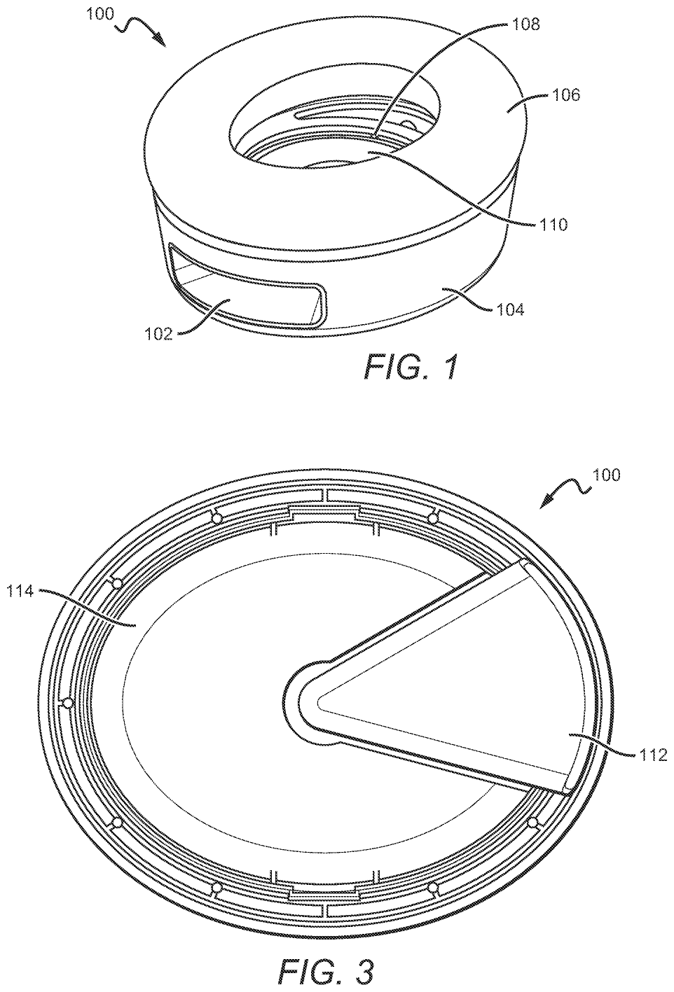

FIG. 1 shows a perspective view of an earcup 100 having a headset audio system of the inventive subject matter incorporated therein. Vent output 102 is visible an outside surface of enclosure 104. Vent output 102 is elongated, having an upper edge, a lower edge, and two side edges. As drawn in FIG. 1, vent output 102 features a rectangular shape having rounded corners. Other shapes are also contemplated and can be implemented without departing from the inventive subject matter. FIG. 1 also shows other components of earcup 100, including padding 106 (e.g., intended to make earcup 100 comfortable when worn), driver cover 108, and diaphragm 110.

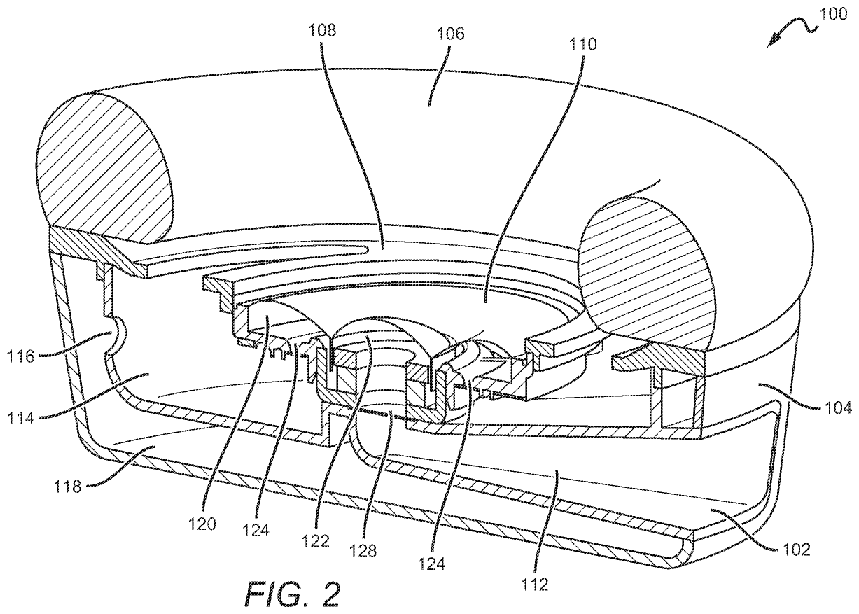

FIG. 2 shows a cutaway view of earcup 100. Vent output 102, enclosure 104, padding 106, driver cover 108, and diaphragm 110. This view also shows many of the earcup's internal components, including acoustic chamber 114. In some embodiments, acoustic chamber 114 features a vent 116. Vent 116 comprises a through hole allowing for compression waves to exit the acoustic chamber into interior space 118. In some embodiments, vent 116 features an air permeable covering to minimize how much dust can enter acoustic chamber 114. In some embodiments, acoustic chamber 114.

Speaker diaphragm 110 can be described as having two spaces behind it. Annular space 120 rests behind an outer portion of diaphragm 110 and center space 122. Annular space 120 features one or more annular vents 124 that are disposed around the earcup's speaker driver assembly (shown as the components below the center of the diaphragm 110). Specifically, annular vents 124 are disposed on diaphragm mount 134. Annular vents 124 are configured to allow compression waves to pass from annular space 120 into acoustic chamber 114. From there, those compression waves will reflect around within acoustic chamber 114 before exiting through vent 116. In embodiments without vent 116, compression waves enter acoustic chamber 114 and reflect within the chamber until the waves lose energy.

Center space 122 allows for compression waves to travel downward and into vent passage 112. To get to vent passage 112, compression waves first pass through air permeable membrane 128. Once in vent passage 112, compression waves can exit vent passage via vent output 102. Vent output 102 can allow compression waves to travel out into ambient air, or, in some embodiments, vent output 102 can allow compression waves to pass into, e.g., interior space 118. In such embodiments, vent passage 112 would not be as long such that vent output 102 does not reach the external wall of enclosure 104 and thus allows compression waves to enter interior space 118 instead of venting to ambient air.

Vent passage 112 is formed into a horn shape to, e.g., reduce or eliminate Helmholtz resonance that could occur as air passes over vent output 102. Vent passage 112 dimensions and vent output 102 can vary depending on the speaker driver assembly used in a particular earcup or headset. For example, vent passage 112 can longer, shorter, expand at different rates, or expand in a way such that the walls of vent passage 112 are not non-planar. In some embodiments, vent output 102 has a cross-sectional area that is at least double the cross-sectional area of internal vent opening 132. In some embodiments, vent output 102 has a cross-sectional area that is at least double the cross-sectional area of the horn portion's narrowest point. In the embodiment shown in the figures, vent passage 112 expands linearly (e.g., its walls are straight outside of curvatures to join the walls).

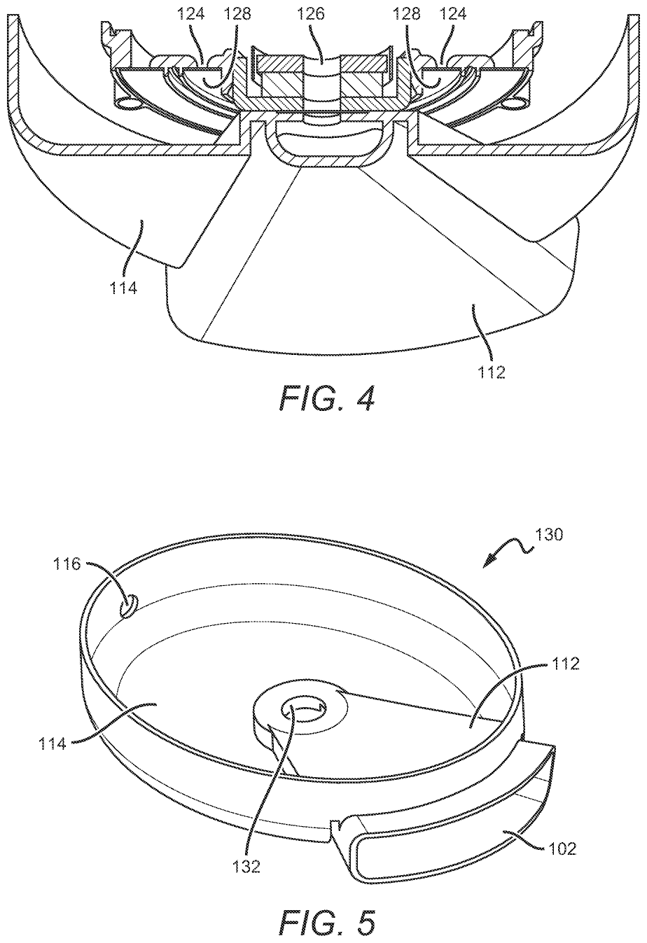

FIG. 3 shows earcup 100 from the bottom with enclosure 104 hidden. This view shows the structural elements that make up the acoustic chamber 114 and vent passage 112. FIG. 4 shows a cutaway view of the acoustic chamber 114 and vent passage 112. Diaphragm 110, driver cover 108, and several other components are hidden to make it easier to see the visible components. In this view, acoustic chamber 114 and annular vents that allow compression waves to enter acoustic chamber 114 are visible. Center passageway 126 between center space 122 and vent passage 112 is also shown. Center passageway 126 creates a pathway for compression waves to pass into vent passage 112 so those compression waves can exit earcup 100 via vent output 102. FIG. 4 makes it easier to see air permeable membranes 128 that cover annular vents 124. These air permeable membranes help minimize accumulation of dust in sensitive areas behind diaphragm 110.

FIG. 5 shows chamber and vent element 130 on its own. Chamber and vent element 130 comprises vent passage 112, vent output 102, internal vent opening 132, acoustic chamber 114, and vent 116. Internal vent opening 132 is where compression waves enter vent passage 112 so they can exit vent and chamber element 130 via vent output 102. In some embodiments, internal vent opening 132 can additionally include an air permeable membrane identical to those that can be included over annular vents 124.

Thus, specific systems and methods directed to headset audio technology have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A headset audio system, comprising:
a diaphragm mount comprising an annular vent;
a speaker diaphragm coupled with the diaphragm mount and configured to generate sound, wherein the speaker diaphragm and the diaphragm mount form an annular space and a center space;
a chamber and vent element comprising an acoustic chamber, a horn-shaped vent passage, and a vent output;
wherein a first portion of sound generated by the speaker diaphragm passes through the annular vent into the acoustic chamber;
wherein a second portion of sound generated by the speaker diaphragm passes through a center passageway into the horn-shaped vent passage and out the vent output.

2. The system of claim 1, wherein the acoustic chamber comprises a vent.

3. The system of claim 1, wherein the annular vent is covered by an air permeable membrane.

4. The system of claim 1, wherein an air permeable membrane is disposed between the center passageway and an internal vent opening that leads to the horn-shaped vent passage.

5. The system of claim 1, wherein the vent output comprises a first cross-sectional area and an internal vent opening that leads to the horn-shaped vent passage comprises a second cross-sectional area, and wherein the first cross-sectional area is less than half of the second cross-sectional area.

6. The system of claim 1, wherein the horn-shaped vent passage expands linearly.

7. The system of claim 1, further comprising an internal vent opening disposed between the horn-shaped vent passage and the center passageway, wherein the internal vent opening is disposed orthogonally to the vent output.

8. A headset audio system, comprising:
an enclosure;
a driver cover coupled with the enclosure to create an internal space;
a chamber and vent element disposed within the internal space and coupled with both the enclosure and the driver cover;
a diaphragm mount coupled with the driver cover and comprising at least one vent;
a speaker diaphragm coupled with the diaphragm mount and configured to generate sound, wherein the speaker diaphragm and the diaphragm mount form an annular space and a center space;
a chamber and vent element comprising an acoustic chamber, a horn-shaped vent passage, and a vent output;
wherein a first portion of sound generated by the speaker diaphragm passes through the annular vent into the acoustic chamber;
wherein a second portion of sound generated by the speaker diaphragm passes through a center passageway into the horn-shaped vent passage and out the vent output.

9. The system of claim 8, wherein the acoustic chamber comprises a vent.

10. The system of claim 8, wherein the annular vent is covered by an air permeable membrane.

11. The system of claim 8, wherein an air permeable membrane is disposed between the center passageway and an internal vent opening that leads to the horn-shaped vent passage.

12. The system of claim 8, wherein the vent output comprises a first cross-sectional area and an internal vent opening that leads to the horn-shaped vent passage comprises a second cross-sectional area, and wherein the first cross-sectional area is less than half of the second cross-sectional area.

13. The system of claim 8, wherein the horn-shaped vent passage expands linearly.

14. The system of claim 8, further comprising an internal vent opening disposed between the horn-shaped vent passage and the center passageway, wherein the internal vent opening is disposed orthogonally to the vent output.

15. The system of claim 8, wherein the speaker diaphragm couples with an underside of the driver cover.
